(19) United States
(12) Patent Application Publication
(10) Pub. No.: US 2014/0126670 A1
(43) Pub. Date: May 8, 2014

(54) METHOD AND APPARATUS FOR NONLINEAR-CHANNEL IDENTIFICATION AND ESTIMATION OF NONLINEAR-DISTORTED SIGNALS

(71) Applicant: DATUM SYSTEMS, INC., San Jose, CA (US)

(72) Inventor: Peter Monsen, Stowe, VT (US)

(73) Assignee: DATUM SYSTEMS, INC., San Jose, CA (US)

(21) Appl. No.: 14/073,247

(22) Filed: Nov. 6, 2013

Related U.S. Application Data
(60) Provisional application No. 61/723,564, filed on Nov. 7, 2012.

(51) Int. Cl. H04B 1/04

(52) U.S. Cl. CPC H04B 1/0475
USPC 375/296

(57) ABSTRACT

The present disclosure provides methods and apparatuses for nonlinear channel identification and estimation of the distorted signals in digital data transmission systems that include signals traversing a dispersive nonlinear channel that produces noisy distorted signals. The identification and estimation are accomplished with an amplitude-based signal expansion and are adapted for changing nonlinear distortion effects using a Least-Means Square direct solution that includes a precomputed matrix.

### FIELD OF INVENTION

The present invention relates to digital data modulation systems that include signals traversing a dispersive nonlinear channel that produces noisy distorted signals and that employ techniques for nonlinear channel identification and estimation of the distorted signals.

### BACKGROUND OF THE INVENTION

A digital-data transmission system transmits digital data over a transmission media where recovery of the digital data is accomplished. During transmission, the digital data is conventionally converted to discrete-time constellation signals that are selected from a finite M-ary constellation alphabet. These constellation signals are subsequently converted to continuous-time transmission signals. Prior to, or during, transmission these signals may be distorted by nonlinear elements, for example a nonlinear power amplifier in the transmitter of a radio system. At a receiver, continuous-time received signals are converted to discrete-time receiver signals by frequency conversion from transmission frequencies to baseband, filtering, and periodic signal sampling. The receiver signals contain distorted-constellation signals and noise signals. Typically, the nonlinear element has a zero-memory nonlinearity but linear filtering prior to and after the nonlinear element produces dispersive nonlinear distortions. Consequently, a distorted-constellation signal depends in a nonlinear functional relationship on multiple successive constellation signals. Accordingly, the channel producing the receiver signals from the constellation signals can he represented as a discrete-time dispersive nonlinear channel.

In cancellation systems, such as successive-interference cancellation (SIC), the noise signal contains a desired signal. For example, in multiuser applications a SIC receiver can be used to cancel nonlinear-distorted interference, that is associated with a previously-demodulated stronger user, in order to demodulate the next weaker user. Accordingly, in cancellation systems, it is desirable to estimate the distorted-constellation signal and subtract the estimate from the receiver signal to obtain an estimate of the desired signal. These cancellation systems conventionally include a copy of the constellation signal sequence that is either reproduced from a known source or estimated in an earlier demodulation operation. The distorted-constellation signal estimate is found by characterizing the discrete-time dispersive nonlinear channel using the constellation signal copies as channel inputs. A best characterization minimizes the mean square difference between the receiver signals and the channel outputs. For this best characterization, the estimates of the distorted-constellation signals are the channel outputs.

Demodulation systems obtain the digital data from the receiver signals and the demodulation can be improved with estimates of the distorted-constellation signals. To obtain these estimates, one can use past binary-data decisions and hypotheses to generate source signals that are associated with the unknown constellation signals. The estimates are then found as described above in the cancellation system using the source signals as channel inputs,

Additionally there are channel identification applications where it is desirable to characterize the discrete-time dispersive nonlinear channel. Such a characterization can be accomplished from an estimation of the distorted-constellation signals given the constellation signals, as described above.

Distortions produced by a signal that traverses a nonlinear channel are often characterized by a Volterra series expansion. The Volterra series is a generalization of the classical Taylor series. See “Nonlinear System Modeling Based on the Wiener Theory”, Proceeding of the IEEE, vol. 69, no. 12, pp. 1557-1573, December 1981. U.S. Pat. No. 3,600,681 discloses a nonlinear equalizer based on a Volterra series expansion of nonlinear intersignal interference (NISI) in a data communication system. In “Adaptive Equalization of Channel Nonlinearities in QAM Data Transmission Systems”, D. D. Falconer, Bell System Technical Journal, vol. 57, No. 7, September 1978, [Falconer], the Volterra series for NISI is used in a passband decision feedback equalizer. This equalizer is adapted by adjusting the coefficients of the Volterra series expansion by a gradient algorithm. In Falconer, it was concluded that “the number of nonlinear terms . . . is potentially enormous” and that “the simulation results indicated that inclusion of a large number of nonlinear terms, . . . may be necessary.” The complexity of the Volterra series expansion for either voiceband telephone channels or satellite channels with nonlinear power amplifiers has been recognized in “Efficient Equalization of Nonlinear Communication Channels, W. Frank and U. Appel. 1997 IEEE International Conference on Acoustics, Speech, and Signal Processing, vol. III, Apr. 21-24, 1997. [Frank]. In Frank, it is described that a decision feedback equalizer (DFE) uses a nonlinear structure that is a good approximation to the general Volterra filter but with reduced complexity. The nonlinear structure is based on an equivalent lowpass model of a 3^{rd} order bandpass nonlinearity. Because this Volterra series approximation provided better improvements at higher signal-to-noise ratio, it is concluded in Frank that the Volterra approximation DFE is better suited to the voiceband telephone channel than radio communications.

Rather than provide compensation for nonlinear distortions at the receiver by using nonlinear equalizers, there are predistortion techniques that can be applied in the transmitter before the nonlinear channel. In “A Data Predistortion Technique with Memory for QAM Radio Systems”, IEEE Trans. Communications, Vol. 39, No. 2, February 1991, G. Karam and H. Sari, [Karam], explicit expressions are derived for the 3^{rd} and 5^{th} order inverse Volterra kernels. Karam also notes that the finite-order inverses grow “very rapidly” with the Volterra order p and the discrete-time signal memory span K. These small order/memory span Volterra inverses are compared in Karam with a lookup memory encoder (referred to as “global compensation” in Karam) that predistorts each possible discrete-time signal data value such that at the discrete-time channel output the center of gravity of the received points is in the correct position in the discrete-time signal constellation. The RAM implementation of the lookup memory encoder requires K log₂ M address bits where M is the modulation alphabet size. By using a rotation technique based on the center discrete-time signal in the memory span, the number of address bits can be reduced in M-ary QAM by two because of quadrature-phase symmetry. For a given memory span and a practical number of address bits, it is described in Karam that the lookup memory encoder outperforms the Volterra inverse predistortion. However, Karam does not describe a technique for initializing and adapting the lookup memory encoder in the presence of additive noise. Unfortunately, the preamble length for initialization of a predistortion lookup memory encoder can be excessively large. The preamble length is on the order of AM^{K-1} discrete-time signals where A is the averaging time to make the additive noise small compared to an acceptable level of residual distortion. A typical averaging time of 100 discrete-time signals for 8 PSK with K=5 would require a preamble of over 400,000 discrete-time signals. This difficulty with initialization and adaptation of distortion compensation systems using lookup table techniques is also noted in “modeling and Identification of a Nonlinear Power-Amplifier with Memory for Nonlinear Digital Adaptive Pre-Distortion”, Proceedings of the SPAWC Workshop, 15-18.6.2003, Rome Italy, by Aschbacher et al, [Aschbacher]. Also recognizing the slow convergence and large number of coefficients in the Volterra series expansion, it is suggested in Aschbacher to identify a nonlinear power amplifier by a simplified Wiener-model consisting of a linear filter followed by a zero-memory nonlinearity. An adaptive Least Means Squares algorithm is used to adapt and track parameters in the linear filter and the zero-memory nonlinearily to minimize the mean square error between the sampled data output of the nonlinear power amplifier and the simplified Wiener-model. This minimization is over the signal bandwidth rather than the smaller discrete-signal bandwidth and the minimization does not include receiver filtering contributions to the nonlinear intersignal interference. As a result interference cancellation with the Aschbacher identification model would not be as effective as a technique that is receiver based and minimizes a mean square error die received discrete-time signal values.

Accordingly, there is a need at a receiver terminal in certain digital-data communication systems with discrete-time signals that traverse a nonlinear-dispersive channel for estimation of the received distorted signal. It would be desirable to utilize nonlinear techniques that provide faster convergence of the nonlinear series expansion and better performance than prior art systems based on conventional Volterra series expansion techniques. Additionally, it would be desirable that these nonlinear techniques can be initialized and adapted to changing conditions more effectively than prior art lookup memory techniques.

### SUMMARY OF THE INVENTION

An object of the invention is to provide a method and estimator for estimating nonlinear-distorted signals using a series expansion of the distortion-producing nonlinearity that has improved convergence and performance relative to a conventional Volterra series expansion. Another object of the invention is to provide for efficient initialization and adaptation of the distorted-signal estimation.

The foregoing and other objects are achieved in a method at a receiver and in a receiver estimator apparatus that employs an amplitude-based nonlinear series expansion for purposes of estimating received nonlinear-distorted signals. The series expansion exploits the characteristics of a dispersive nonlinear channel that contains a zero-memory amplitude-dependent nonlinearity surrounded by linear filters.

Further, according to the present invention, a method is provided, for use with discrete-time signals, selected from a finite, complex constellation, that are used in a discrete-time nonlinear channel with an input signal sequence and an output source sequence, where each output signal in the output signal sequence includes a noise signal and a distorted signal, that has an unknown nonlinear functional relationship that depends on a block of K successive source signals, one of which is sequence aligned with the output signal, for estimating the distorted signal from the output signal and the block source signals, including the steps of: phase-rotating the source signals in the block by a rotation value, that is a function of the phase of the sequence-aligned source signal in the block; producing estimator signals that include signals that arc products of one or more real values of products of phase-rotated signals in the block; multiplying each of the estimator signals by an associated estimator weight, and summing the products to produce a rotated estimate; and subtracting the phase of the rotation value from the phase of the rotated estimate to produce the distorted-signal estimate.

Further, according to the present invention, a signal estimator is provided, for use with discrete-time signals, selected from a finite, complex constellation, that are used in a discrete-time nonlinear channel with a source signal sequence and an output signal sequence, where each output signal in the output signal sequence includes a noise signal and a distorted signal, that has an unknown nonlinear functional relationship that depends on a block of K successive source signals, one of which is sequence aligned with the output signal, for producing a distorted-signal estimate from the output signal and the block source signals, the signal estimator including at least: a block generator for phase-rotating the source signals in the block by a rotation value, that is a function of the phase of the sequence-aligned source signal in the block; an estimator signal generator for producing estimator signals that are products of one or more real values of products of phase-rotated signals in the block; an estimator weight calculator for calculation of estimator weights; and a dot-product multiplier for multiplying each of the estimator signals by an associated estimator weight and summing the products to produce a rotated estimate and for further multiplying the rotated estimate by the complex conjugate of the rotation value to produce the distorted-signal estimate.

Other aspects and embodiments of the invention are discussed below.

### BRIEF DESCRIPTION OF THE DRAWINGS

For a fuller understanding of the nature and desired objects of the present invention, reference is made to the following detailed description taken in conjunction with the accompanying drawing figures wherein reference numbers refer to the same, or equivalent, parts of the present invention throughout the drawings, and wherein:

FIG. 1 is a block diagram of a discrete-time nonlinear system for transmission of digital data

FIG. 2 is a graph of the amplitude and phase outputs as a function of input power for a typical power amplifier that defines the nonlinear channel of FIG. 1;

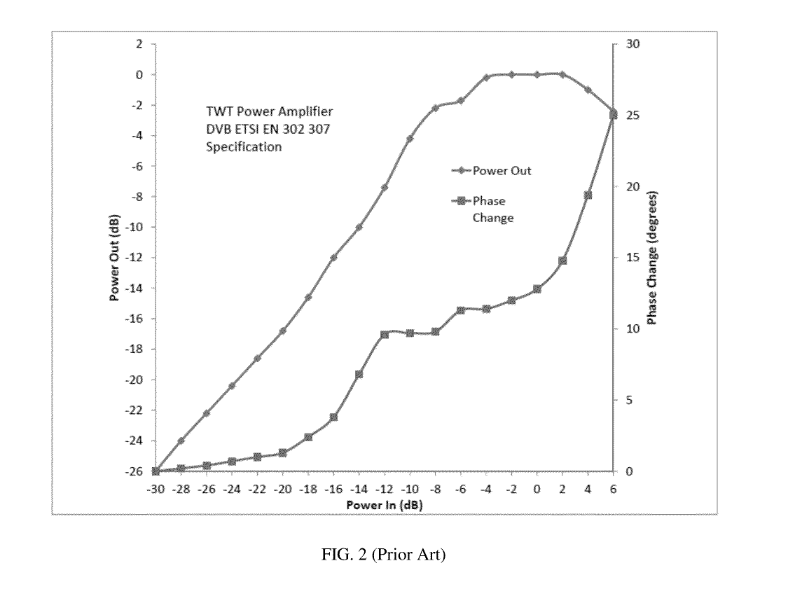

FIG. 3 is a block diagram of the distorted-signal estimator of FIG. 1; and

FIG. 4 is a block diagram of an example signal estimator device.

### DEFINITIONS

The instant invention is most clearly understood with reference to the following definitions:

As used in the specification and claims, the singular form “a”, “an” and “the” include plural references unless the context clearly dictates otherwise.

### DETAILED DESCRIPTION OF THE INVENTION

### Digital-Data Transmission Systems

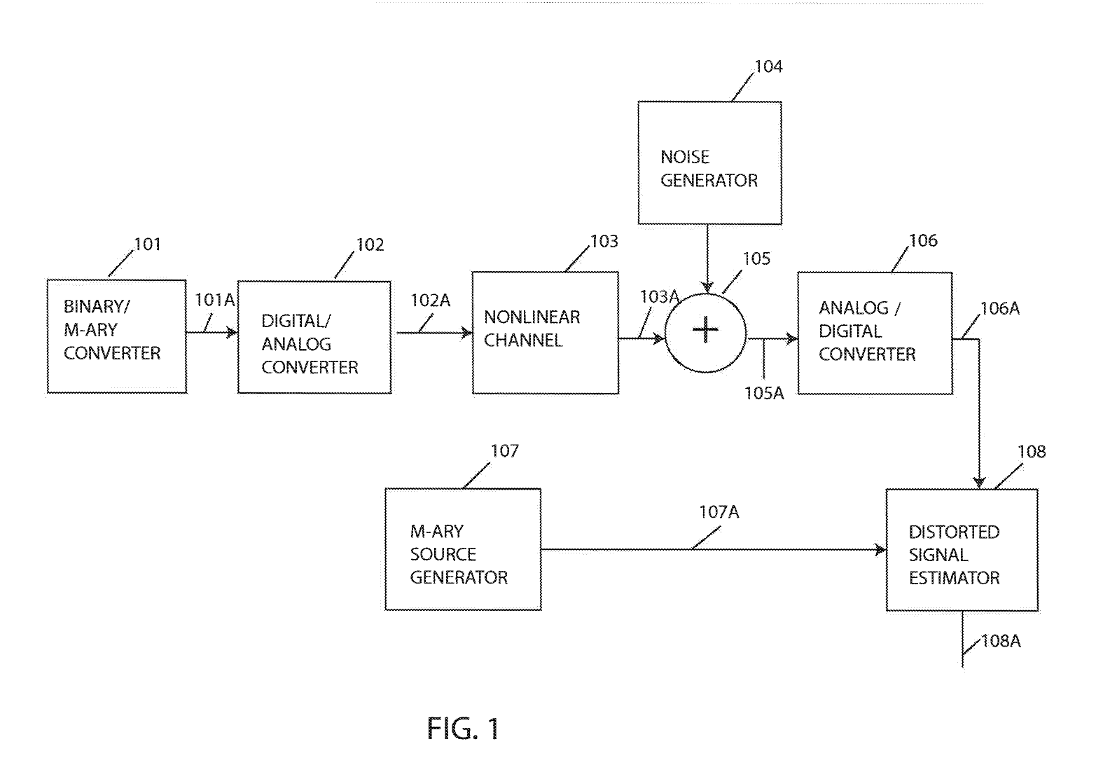

A digital-data transmission system transmits digital data, generally binary data, over a transmission media where recovery of the digital data is accomplished. The transmission system includes modulation at a transmitter and demodulation at a receiver. The modulation is conventionally accomplished in two steps. As shown in FIG. 1 a binary/M-ary converter 101 produces binary data that are converted to a constellation sequence 101A that includes discrete-time constellation signals that are selected from a finite M-ary constellation alphabet. In a second modulation step, digital/analog converter 102 converts the constellation sequence 101A to a modulation signal 102A that include a carrier frequency appropriate for the transmission medium, e.g. radio, optical, etc. The constellation signals and modulation signal are realized with cosine and sine carrier components that allow for a complex representation. Conventionally, the real (imaginary) part of a signal is associated with the cosine (sine) carrier component.

Accordingly, the constellation alphabet for the constellation sequence 101A is complex. Constellation examples include: Quadrature Phase-Shift Keying (QPSK), M-ary Phase-Shift Keying (MPSK), Quadrature Amplitude Modulation (M-QAM), etc. Examples of constellation alphabets, unity-magnitude normalized, are given in Table 1.

TABLE 1
Example Constellation Alphabets

| Modulation | Alphabet |
|---|---|
| QPSK | (±1 ± j)/\sqrt{2} |
| 8-PSK | e^{jnπ/4}, n = 0, 1, 2, . . . , 7 |
| 16-QAM | (±1 ± j)/\sqrt{2} |
| | (±1 ± j/3)/\sqrt{2} |
| | (±1/3 ± j)/\sqrt{2} |
| | (±1/3 ± j/3)/\sqrt{2} |

In general, the present invention includes any digital-data modulation technique with a constellation alphabet with a finite set of complex numbers.

The digital/analog converter 102 employs a waveform filter to convert the constellation sequence to a continuous-time modulation signal 102A with appropriate spectral limitations for subsequent medium transmission. A waveform filter is characterized by its filter impulse response, f_{T}(t). Consecutive discrete-time constellation signals in the constellation sequence 101A are applied in the form of an impulse train to the waveform filter to produce a series of successive waveforms that forms a continuous-time baseband signal. For transmission, the baseband signal is upconverted to the modulation signal 102A at a radian carrier frequency, ω₀. Each successive waveform has an associated constellation signal value from the selected constellation alphabet. For period-T constellation signals, i_{n,} n integer, the complex notation representation of the modulation signal 102A is

i(t)=Σ_{n=-∞}^{∞}iₙf_{T}(t−nT). (1)

where the constellation signal i is selected from an M-ary alphabet, α(q), q=0,1,2 . . . , M-1. The modulation signal 102A is a real continuous-time signal given by

i_{B}(t)=Re{i(t)e^{jω}^{₀}^{t}}. (2)

The bandwidth of modulation signals is determined by the waveform filter. If the waveform impulse response fᵣ(t) has a roll-off factor of η, 0<η<1, the bandpass (two-sided) bandwidth of the modulation signal is approximately B=(1+η)/T. Typical values for roll-off factors are 0.3 to 0.6.

In a transmitter and/or in a transmission media the modulation signal 102A traverses a nonlinear channel 103 that produces a distorted-modulation signal 103A. An important example of nonlinear channel 103 is a power amplifier in the transmitter of a radio system. In general, power amplifiers are linear for smaller input signals but produce amplitude and phase distortions for larger input signals until a saturation level is reached where no further output amplitude increase is possible. This nonlinear effect can be accurately modeled by a zero-memory nonlinear function between the input signal amplitude and the output amplitude and phase. In this amplitude-phase model as described by A. L. Berman and C. H. Mahle, “Nonlinear phase shift in traveling-wave tubes as applied to multiple access communication satellites”, IEEE Trans. Communication Technology, vol. COM-18, p. 37-48, February 1970, an input bandpass signal corresponding to the complex-notation modulation signal of Eq. (1) can be written as

i(t)=a(t)e^{jθ(t)}, (3)

where a(t) and θ (t) are the signal amplitude and phase, respectively. The corresponding distorted-modulation signal for this amplitude-phase model is

î(t)=A[a(t)}e^{jθ(t)+jθ(a(t))}, (4)

where A(a) is a nonlinear function of a, with a leading linear term, representing amplitude distortion and Φ (a) is a nonlinear function of a, representing phase distortion.

An example of this amplitude-phase model is provided in European Standard ETSI EN 302 307 v 1.2.1, (2009-08), Digital Video Broadcasting [DVB], pg 73, as a Tracking Wave Tube (TWT) amplifier model to be used in satellite communication system computer simulations The Ku-band linearized TWT amplifier amplitude A (a) and phase Φ (a) functions are reproduced here from DVB, Figure H.11 as FIG. (2).

Although the power amplifier nonlinearity has zero memory, i.e., the amplitude and phase distortion depend only on the amplitude a(t) at any instant of time, linear filters, prior to and after the power amplifier, result in a dispersive nonlinear characterization that depends on the constellation signal sequence iₙ and the linear filters.

A transmission-noise signal is produced in a noise generator 104 and is combined in an adder 105 with the distorted-modulation signal 103A to produce at a receiver a received signal 105A. The first step in digital-data demodulation at a receiver converts the received signal 105A in an analog/digital converter 106 to produce a receiver sequence 106A that includes discrete-time receiver signals. Analog/digital converter 106 includes a down-converter for converting the received signal 105A to baseband, a receiver filter for reducing out-of-band signals and noise, and a periodic sampler to produce the receiver sequence 106A with period-T receiver signals denoted as rₙ, n integer. In the analysis to follow, the receiver filter is assumed to have a memory span of LT seconds and this span is at least as long as the duration of the waveform filter impulse response. It is also assumed here for this digital-data transmission nonlinear channel system that gain-control results in a unity gain transmission. The receiver sequence 106A, for an ideal(e.g., no intersymbol interference), synchronized, and linear-only realization of nonlinear channel 103 in the absence of noise, would be equal to the constellation sequence 101A, i.e., rₙ=iₙ, n integer.

For a linear channel, the optimum receiver filter is a matched filter that is matched to the combination of the waveform filter in the transmitter and a channel filter that includes the linear distortions produced in the transmission medium. In radio systems that operate under line-of-sight conditions, the channel filtering effects are small but also unknown so the receiver filter is conventionally matched to the waveform filter. A matched filter is mathematically defined as an anticausal filter with impulse response f*(−t) where f(t) is the waveform filter impulse response that is defined as zero for t<0. In the described system, there is an anticausal receiver filter with impulse response f*(−t). In a preferred embodiment, the receiver filter is matched to the waveform filter, such that f(t)=f_{T}(t). Because the receiver filter is anticausal, a practical implementation requires the introduction of an implementation delay. The implementation delay must be at least as long as the duration of the receiver filter impulse response. In this description, the transmission delay, which includes this implementation delay, has been normalized to a synchronization offset value τ, −T/2<τ<=T/2.

In the receiver sequence 106A, each received signal rₙ, includes a distorted-constellation signal [symbol] and a receiver-noise signal uₙ;

τₙ₌ [symbol] +uₙ, (5)

where the distorted-constellation signal is produced from the receiver filtering and periodic sampling in analog/digital converter 106 of the distorted-modulation signal 103A, Eq. 4, to produce

[symbol]

(τ)=∫_{nT-τ}^{nT+LT+τ}f*(t+τ−nT) [symbol] (t)dt. (6)

where τ is the synchronization delay. For τ=0 the distorted-constellation signal is equal to the constellation signal, iₙ for a channel with no distortion. Because of a bandpass bandwidth limit B<2/T of the receiver filter, a representation, by sin(πt)/πt interpolation, of the continuous-time distorted-constellation prior to the receiver sampling can be produced from a periodic succession of any two discrete-time distorted constellation signals, Eq. (6), that are separated by T/2. In this invention, estimation techniques are described that apply in general for any value of synchronizing delay τ. In particular, special considerations are provided for the synchronized selection, τ=0, and for an antisynchronization selection at τ=T/2. Accordingly, estimates of the distorted-constellation signals can be used in cancellation systems for cancellation of the discrete-time signals at an arbitrary delay r or cancellation of a continuous-time signal using interpolation of pairs of T/2-spaced estimates,

Examination of Eqs.(1, 4, and 6) establishes that the distorted-constellation signal depends on the constellation signal iₙ and previous and future constellation signals. The dependence on previous constellation signals result from the waveform filter in digital/analog converter 102. The future constellation signals are a result of the anticausal receiver filter analog/digital converter 106.

The second step of demodulation in a digital-data transmission system uses the receiver sequence 106A to produce estimates of the transmitted binary data. The present invention is concerned with the first step of demodulation, i.e., producing estimates of the distorted-constellation signals [symbol] n integer. These estimates may be used either in cancellation of the distorted-constellation signals or in the second step of demodulation for the binary data estimates.

The distorted-constellation signals can be expressed as a nonlinear function g of a length K constellation vector, iₙ i.e.,

[symbol]

(τ)=g(iₙ) (7)

where the constellation vector contains the constellation signal iₙ and L1-1 previous and L2-1 future constellation signals;

iₙ=i_{n-L1+1}i_{n-L1+2} . . . iₙ . . . i_{n+L-2}i_{n+L2-1}] (8)

where K=L1+L2−1 and L1,L2 are selected to include the set of significant constellation signals. Since the receiver filter memory span of LT seconds is at least as long as the waveform filter memory span, the selection L1=L2=L includes all the constellation signals that contribute to distortion for τ=0,

Equations (5,7, and 8) define a discrete-time dispersive nonlinear channel with the constellation sequence as the input and the receiver sequence as the output. The present invention provides a technique to estimate the distorted-constellation signals in the receiver sequence and provides a characterization of this discrete-time dispersive nonlinear channel.

In the receiver an M-ary source generator 107 in FIG. 1 generates a source sequence 107A that is associated with the constellation sequence. 101A containing the constellation signals. This association may result either from a connection to the output of binary/M-ary converter 101 in the transmitter for obtaining the constellation signals or from receiver decisions and/or hypotheses for the constellation signals. In the description to follow, it is assumed that the source sequence 107A is identical to the constellation sequence 101A. A Distorted-Signal Estimator (DSE) 108 uses the source sequence 107A and the receiver sequence 106A to produce estimates of the distorted-constellation signals. Additionally, the DSE 108 computes estimator weights that represent a nonlinear characterization of the discrete time dispersive nonlinear channel g(iₙ) of Eq. 7 that produces the distorted-constellation signal ( [symbol] (τ) from the constellation vector iₙ.

### Distorted Signal Estimator (DSE)

The following parameters characterize the DSE 108
T=constellation signal period;
τ=synchronization delay
M=number of signal modulation values in the constellation alphabet;
L=effective time duration of the receiver filter impulse response;
K=memory span of source signals;
P=maximum number of source signals in a nonlinear combination
W=number of estimator weights; and
N=number of receiver signals used in adaptation,

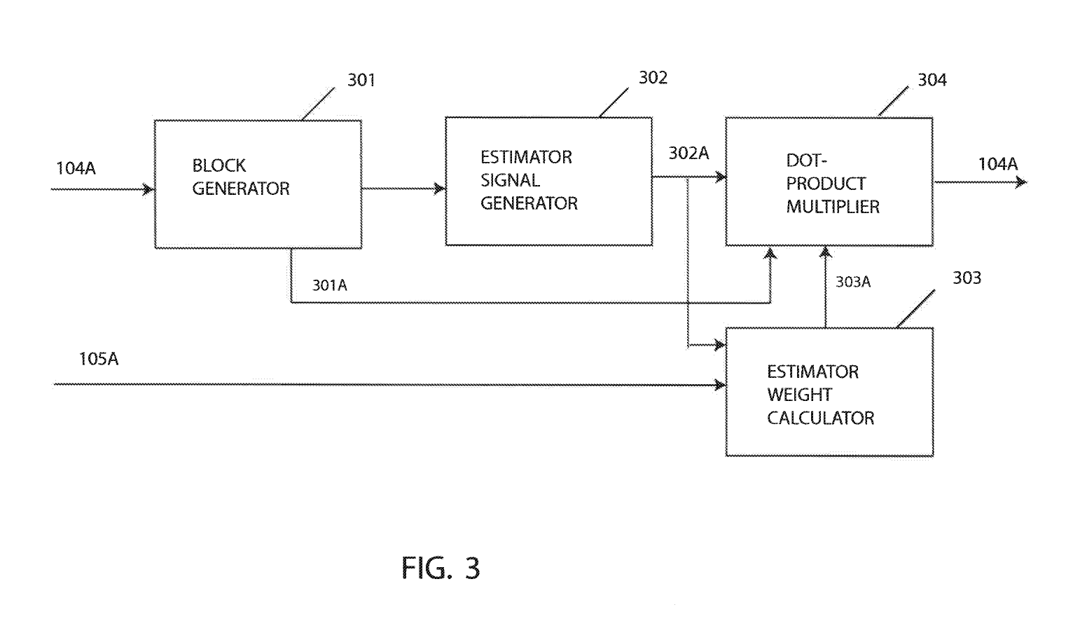

In FIG. 3, which represents the DSE 108, a block generator 301 receives source signals on link 107A from the M-ary source generator 107. The block generator 301, at index time n, periodically produces the block of K source signals as a source vector, iₙ, corresponding to Eq. (8). For synchronized delay τ=0, the block length parameters selected are L1=L2=L such that K is odd and the source signal iₙ is sequence-aligned with the distorted-interference signal, Eq. (7). Within the block, the source signal iₙ is centered and is designated as the center signal in the block. For the antisynchronized delay τ=T/2, the block length parameters selected are L1=L2=L+1 such that K is even and the source signals iₙ and iₙ₋₁ are both center signals in the block because they are the two sequence-aligned signals that are the most significant, and symmetrical, contributors to the distorted constellation signal at τ=T/2. These center designations will be used subsequently to define symmetry conditions that result in adaptive weights with better estimation. The block generator 301 also exploits a phase-rotation symmetry that depends on the fact that the norlinearity in the continuous system depends only on the amplitude of the signal input to the nonlinearily and not its phase. In this phase-rotation symmetry technique, all the source signals in the block are multiplied by a rotation value that depends on the phase of the center signal or on the phase of one of the two center signals. The rotation value has a unit magnitude and a phase such that the multiplication results in phase rotation. This rotation multiplication results in a source-signal block with rotated-source signals in which the rotated-center signal always has phase in the first quadrant of the complex plane, i.e., a phase between zero and 90 degrees. For example, in non-constant modulations such as 16 QAM, the rotation value is equal to (1, −j, −1, j) if the center signal is located in respective quadrants (1, 2, 3, 4).

By using an amplitude-based nonlinear expansion, to be described subsequently, of the nonlinear relationship to the block rotated-source signals, a sot of W real estimator signals are derived in an estimator signal generator 302. Each estimator signal contains products of one or more real values of products of rotated-source signals in the block. The product combinations of p rotated-source signals is less than or equal to P, the maximum nonlinear combination in the series expansion. A set of W complex estimator weights are computed, using a Least Means Square (LMS) direct solution to be described subsequently, in an estimator weight calculator 303 that uses as inputs N previous received signals rₖ, k<n. 106A, and their associated estimator signals 302A. These estimator weights 303A are provided to a dot-product multiplier 304 where they multiply the associated real estimator signals 302A. For a W-dimensional estimator these estimator weights and estimator signals are represented by W-vectors from which a scalar output can be calculated as the vector dot product. In order to unrotate the effects of the phase rotation of the source signals, the rotation value is provided on a link 301A to the dot-product multiplier 304 where the complex conjugate of the rotation value multiplies the vector dot product to produce the distorted-constellation signal estimate 108A of the distorted-constellation signs [symbol] .

In the preferred embodiment, the receiver filter is selected as a matched filter to the waveform filter resulting in a Hermetian-sequence symmetry in the source signal block. To exploit this sequence symmetry, the source signal block length, K, has the center signal iₙ exactly centered within the block for K odd. For K even, the center signal is selected, in a manner to be described subsequently, between the two center signals, iₙ and iₙ₊₁. Within the block for K odd, there are K2L−1 source signals iₙ₊ᵢ with index times n+i, −L+1≦i≦L−1. Within the block for K even, there are K=2L source signals iₙ₊ᵢ with index times n+i, −L+1≦i≦L. The selection L has been determined as the effective length LT of the receiver filter impulse response. The Hermetian-sequence symmetry results because the response of the discrete-time dispersive nonlinear channel is a function of the autocorrelation of the waveform filter impulse response. This autocorrelation is Hermetian—sequence symmetric that results in sequence symmetry for the K odd and K even examples. This sequence symmetry is exploited in the definition of the estimator signals such as to give the estimator greater flexibility in the estimator weight optimization. For K odd, there is symmetry with respect to an early (relative to the rotated center signal) subblock of rotated source signals and a late (relative to the rotated center signal) subblock of rotated source signals. For K even, there is symmetry with respect to an early (including the lower-indexed center signal) K/2 subblock and a late (including the higher-indexed center signal) K/2 subblock of rotated source signals. The early and late subblocks in the source signal block are assigned respective early and late words equal to a number between 1 and M^{L} by M-ary conversion of the L signals in each subblock. A sequence symmetry criterion is defined as the lower word weight, i.e., the word number, for the early subblock must be less than or equal to the word weight for the late subblock. In the determination of the rotated source-signal block, the subblocks are complex-conjugate reversed if the sequence symmetry criterion is not satisfied. Simulation tests with and without this sequence symmetry criterion showed significantly superior estimation with sequence symmetry.

### Mathematical Development of the Distortion-Signal Estimator

An amplitude-based series expansion approach is given here to describe the linear and nonlinear signal components of the distorted-constellation signal. The DSE uses this series expansion to generate estimator weights that lead to the distorted-constellation signal estimate. The distorted-constellation signal is given by Eq. (6) which can be rewritten in terms of a linear operator [symbol] ₙ to represent the linear receiver filtering and sampling to give the functional relationship

[symbol]

(τ)= [symbol] ₙ(G(i)). (9)

where [symbol] (t)=G(i(t) and G represents the zero-memory nonlinearity of Eq. (4). The nonlinear function G has a Taylor series expansion with a linear and nonlinear term

G(i)=G₁i+G₂ nT≦t+τ<nT+LT, (10)

where G₁ is the complex coefficient of the linear term. The nonlinear complex term G₂ is seen from Eq. (4) to depend only on the amplitude of i(t). Because of this amplitude dependence, it follows that an amplitude-based series expansion should provide better convergence properties than a general Volterra series expansion that ignores this amplitude dependence. Because of the monotonic relationship of the amplitude-squared to the amplitude, the nonlinear term can also be expressed as a function of the amplitude-squared. This choice leads to a simpler nonlinear expansion because the amplitude-squared can be expressed as a closed-form function of i(t). This amplitude-squared dependence of G₂ on i(t) is then written as

G₂=G₂(|i(t)| [symbol] 2), nT≦t+τ<nT+LT. (11)

The functional relationship of Eq. (8) can be decomposed into a linear term with vector component g₁ and a nonlinear component, giving

[symbol]

=g₁ⁱiₙ+yₙ, (12a)

where the nonlinear distortion component is given by

yₙ [symbol] ₙG₂(|i(t)| [symbol] 2), nT≦t+τ<nT+LT. (12b)

Note the linear term in Eq. (12a) includes an intersignal interference (ISI) vector g₁. Conventionally, the impulse response at) of the waveform filter is selected such that its autocorrelation function satisfies the Nyquist zero-ISI criterion, (see John Proakis, Digital Communications, McGraw-Hill, New York, N.Y., 1983, sec. 6.2.1), with the result that for the synchronization condition, τ=0, the ISI vector g is zero for all coefficients except for the coefficient of the center signal iₙ the source vector iₙ. The adjacent source signals i_{n+|k|,k≠0} result in K−1 linear intersignal interferers when τ≠0 and K−1 nonlinear intersignal interferers (for any value of τ) as a result of the [symbol] ₙ G₂ joint operation. The nonlinear functional dependence of Eq. (12b) can then be completely expressed in terms of the source vector. The memory span K is equal to the number of signals in the source vector and represents an important parameter of the estimator in terms of performance vs. complexity.

The number of terms in a series expansion can be significantly reduced by exploiting the phase-rotation symmetry described earlier. In this technique, a rotation value multiplies all the source signals in the block to produce rotated signals with a rotated-center signal with phase in the first quadrant of the complex plane. The rotated signals are used in the generation of the estimator signals which then requires unrotation at the estimator output. Accordingly, the estimator output is multiplied by the complex conjugate of the rotation value to produce the distorted-constellation signal estimate. In constant-envelope digital-modulation constellations such as M-ary Phase-Shift-Keying (MPSK) systems, this phase-rotation symmetry technique can be realized by a rotation value equal to the complex conjugate of the center signal. Thus in MPSK, the rotated center signal is always unity (in the first quadrant) and the unrotation is realized by multiplying the estimator output by the center signal. Accordingly for constant envelope constellations, one defines corresponding rotated-source signals by the following phase rotation

\tilde{ι}ₙ₊ₖ=conj(iₘ)*iₙ₊ₖ, k ∈ Cₙ, (13a)

where the rotation index set is

Cₙ={n+k,|k|<L, i≠o}, K odd

Cₙ={n+k,−L+1≦k≦L,i≠m}, K even (13b)

and the selected center signal index m is zero for K odd and a function of the alphabet number q(iₘ), for iₘ−α(q), q=0,1,2 . . . , M-1 for the center signals for K even, viz.,

$$m = Q ( q ( {i}_{0} ) , q ( {i}_{1} ) ) , K even \\ Q = floor ( 2 * \frac{mod ( q ( {i}_{1} ) - q ( {i}_{0 )} , M )}{M} ) = 0 or 1 \qquad ( 13 c )$$

The nonlinear distortion component can then be written as

yₙ=iₘ [symbol] ₙ[G₂(| [symbol] (t)| [symbol] 2)], (14)

where [symbol] (t) is given by Eq. (1) with the phase-rotation substitution of Eq. (13a), Note that the center rotated-source signal is unity for any K set of source signals. Since the center rotated-source signal is always unity, this rotation principle reduces the nonlinear functional dependence from the memory span of K to the number of nonlinear intersignal interferers, K−1, For non-constant digital modulations such as 16 QAM, the rotated-center symbol is always in the first quadrant but its amplitude and phase relative to the ISI must be included in any power series expansion. In the analysis to follow, the equations are for a constant-envelope modulation, which in a straight-forward manner can be extended to the more complicated equations for non-constant modulations.

Note that since yₙ functionally depends on the source vector, the rotation Eq. (13a) implies that it must also depend on the rotated-source vector, i.e.,

yₙ=yₙ(\tilde{ι}ₙ), (15a)

where the rotated-source vector is

\tilde{ι}ₙ={\tilde{ι}_{n-L+1} . . . \tilde{ι}ₙ₋₁, \tilde{ι}ₙ₊₁, . . . \tilde{ι}_{n+L-1}}, K odd.

\tilde{ι}ₙ={\tilde{ι}_{n-L+1} . . . \tilde{ι}ₘ₋₁, \tilde{ι}ₘ₊₁, . . . \tilde{ι}_{n+L}}, K even (15b)

Continuing the above Taylor series expansion to include G₂ and expanding with respect to the magnitude squared gives

G₂=Σₖ₌₁^{∞}aₖ lₖ, lₖ=|\tilde{ι}(t)| [symbol] 2k, nT≦t+τ<nT+LT, (16)

where the aₖ coefficients are complex because G₂ is complex. The k=1 square term in Eq. (16) can be written m terms of the K−1 rotated-source signals with the simplifying notation:

fᵢₜ=f*(t+τ−iT), (17)

l₁=|\tilde{ι}(t)| [symbol] =|fₘₜ+Σ_{i∈C}_{ₙ}\tilde{ι}fᵢₜ| [symbol] 2. (18a)

for the previously defined index set Cₙ. Define the time dependent variable

vₜ=vₜ(n)=Σ_{i∈C}_{ₙ}\tilde{ι}fᵢₜ (18b)

so that the k=1 term can be written as

l₁=|fₘₜ| [symbol] 2+2 [symbol] e(fₘₜvₜ*)+|vₜ| [symbol] 2. (18c)

In the expansion of terms to follow, it is convenient to define additional subsets that depend on Cₙ, namely for i ∈ Cₙ, let

Eₙᵢ={j ∈ Cₙ, f≧i}

Fₙᵢ={j ∈ Cₙ, j>i}

The linear filtering of Eq. (7a) has the integral form for the k=1 term of Eq. (16):

aₗ [symbol] (l₁)=iₘ∫_{NT}^{nT+LT}fₘₜl₁dt.

In a similar manner, higher-order terms for k>1 Eq.(16) can be written as integral products. After integration, combining of terms, and omitting the terms that do not depend on the rotated-source signals, one has a second-order term

$${G}_{2}^{( 2 )} = {\sum }_{i ∈ {C}_{n}} {b}_{i} ℛ e ( {\tilde{i}}_{i} ) + {\sum }_{i ∈ {C}_{n}} {\sum }_{j ∈ {F}_{{n}_{i}}} {b}_{ij}^{( 1 )} ℛ e ( {\tilde{i}}_{i}^{*} {\tilde{i}}_{j} ) + {\sum }_{i ∈ {C}_{n}} {\sum }_{j ∈ {E}_{ni}} {b}_{ij}^{( 2 )} ℛ e ( {\tilde{i}}_{i} ) ℛ e ( {\tilde{i}}_{j} ) . \qquad ( 19 a )$$

where the estimator coefficients bᵢ, bᵢⱼ⁽¹⁾, bᵢⱼ⁽²⁾ are complex and multiply associated estimator signals that arc first or second-order real combinations of the rotated-source signals. The terms in Eq. (19a) take into account the unity magnitude of the constant-envelope source signals and the unit value of the rotated center signal. A third-order term derived from Eq. (16), again with complex estimator coefficients multiplying third order products, is

G₂⁽³⁾=Σ_{t∈C}_{ₙ} Σ_{j∈C}_{ₙ} Σ_{k∈F}_{ₙⱼ}bᵢⱼₖ⁽¹⁾ [symbol] e(\tilde{ι}ᵢ) [symbol] e(\tilde{ι}ⱼ\tilde{ι}ₖ)+Σ_{i∈C}_{ₙ} Σ_{j∈E}_{ₙᵢ} Σ_{k∈E}_{ₙⱼ}bᵢⱼₖ⁽²⁾ [symbol] e(\tilde{ι}ᵢ) [symbol] e(\tilde{ι}ⱼ) [symbol] e(\tilde{ι}ₖ) (19b)

Restricting this series expansion to fourth order or less, one has two additional terms, viz.,

$${G}_{2}^{( 4 )} = {\sum }_{i ∈ {C}_{n}} {\sum }_{j ∈ {F}_{ni}} {\sum }_{k ∈ {C}_{n}} {\sum }_{l ∈ {F}_{nk} l ∈ {E}_{nj}} {b}_{ijkl}^{( 1 )} ℛ e ( {\tilde{i}}_{i}^{*} {\tilde{i}}_{j} ) ℛ e ( {\tilde{i}}_{k}^{*} {\tilde{i}}_{l} ) + {\sum }_{i ∈ {C}_{n}} {\sum }_{j ∈ {E}_{ni}} {\sum }_{k ∈ {E}_{nj}} {\sum }_{l ∈ {E}_{nk} l ∈ {F}_{ni}} {b}_{ijkl}^{( 2 )} ℛ e ( {\tilde{i}}_{i} ) ℛ e ( {\tilde{i}}_{j} ) ℛ e ( {\tilde{i}}_{k} ) ℛ e ( {\tilde{i}}_{l} ) . \qquad ( 19 c )$$

The nonlinear distortion component to Pth order in the rotated-source signals is the sum of Eqs. (19a,19b,19c), viz.,

yₙ=iₘΣₚ₌₂^{p}G₂^{(p)}, P=2,3,4 (20)

In practical applications the nonlinear distortion component yₙ the receiver signal is well approximated by the Pth order, 2<P≦4, expansion, Eq. (20). The linear ISI component, if present, due to the ISI vector in Eq. (9a) can be estimated with a linear-estimator vector w₁ multiplying the rotated-source vector, Eq. (15b).

Note that unlike a Volterra series expansion that depends on nonlinear combinations of rotated-source signals resulting in a complex signal expansion, the amplitude-based series expansion depends only on real parts of combinations of the rotated-source signals resulting in a real signal expansion. This difference is a factor in the improved convergence of the amplitude-based series expansion.

The DSE 108 of Pth order generates the distorted-constellation signal estimate [symbol] that has been unrotated by multiplication of the center signal iₘ, such that

[symbol]

=iₘ*w′\tilde{ι}ₙ+yₙ(\tilde{ι}ₙ). (21)

The total number of weights W in the estimator is equal to K, corresponding to the linear estimator signals, plus the number of coefficients in Eq. (19) corresponding to the nonlinear estimator signals. Additionally for the antisynchronized selection with K even, it was found useful to add additional linear weights symmetrically so as to produce K+Linear Delta weights in the linear portion of the estimator. Table 2 summaries the total number of estimator weights for some important examples.

TABLE 2
Total Number of Estimator Weights

| Nonlinear | Signal Memory | | QPSK | |
|---|---|---|---|---|
| Order | Span | Linear Delta | Weights | 8PSK Weights |
| P | K | Δ | W₄ | W₈ |
| 2 | 3 | 0 | 7 | 9 |
| | 4 | 4 | 17 | 20 |
| | 5 | 0 | 25 | 25 |
| | 6 | 2 | 33 | 38 |
| 3 | 3 | 0 | 8 | 15 |
| | 4 | 4 | 21 | 39 |
| | 5 | 0 | 35 | 69 |
| | 6 | 2 | 53 | 123 |
| 4 | 3 | 0 | 9 | 19 |
| | 4 | 4 | 27 | 57 |
| | 5 | 0 | — | 120 |

The number of weights for QPSK is generally less for 8 PSK because the smaller signal set of QPSK requires some terms to be eliminated in the series expansion such that the number of weights is always less than the number of estimator signals. When this requirement is not met, the correlation matrix in the LMS direct solution can be singular.

### Initializaton/Adaptation of the Nonlinear-Channel Signal Estimator

The distorted-signal estimator 108 requires calculation of complex estimator weights in the estimator weight calculator 303. These estimator weights correspond to the linear weight vector w₁ in Eq. (21) and complex weights corresponding to the b coefficients in Eq. (19). The weight calculation is required for purposes of initialization and for subsequent adaptation in order to track changes, primarily due to temperature, in a nonlinear power amplifier that is a typical realization of the nonlinear channel 103. The common solution to adaptation is to minimize the mean squared value of a residual, i.e., error, signal. In this application, the residual signal is the difference between the receiver signal 106A and the estimate 108A of the distorted-constellation signal, viz.,

zₙ=rₙ− [symbol] (22)

The mean squared value of the residual signal can be shown to be convex, i.e. bowl shape, with respect to the weights, so that a unique minimum exists. This minimum can be found with Least-Mean Squares (LMS) techniques through either an estimated-gradient algorithm or a direct solution. The estimated-gradient algorithm finds an approximation to the minimum by adjusting the weights so as to move in the opposite direction of an estimated gradient. Since the mean of the estimated gradient is zero at the minimum corresponding to the bottom of the bowl, such an estimated-gradient algorithm must converge to the neighborhood of the optimum set of weights. The LMS estimated-gradient algorithm is widely used in adaptation systems because it can conveniently use receiver decisions when the source signals are unknown and additionally the algorithm avoids the complexity of a real-time matrix inversion. However, in this application, when the Hermetian-sequence symmetry, described above, is used to improve the estimation, there exists a large eigenvalue span in an LMS correlation matrix that controls the adaptation. A large eigenvalue span dramatically slows the estimated-gradient adaptation. Further, in this application, the LMS correlation matrix, that is required in the direct solution, depends only on the rotated-source signals and not on receiver signal values. As a result a direct solution with faster adaptation is possible. Since in Eq. (19) all the real combinations that are functions of the rotated-source signals can be precomputed, the matrix required for the direct solution adaptation can also be precomputed. Thus for purposes of weight initialization and tracking, it is not necessary to use a known, i.e., reference, sequence.

To determine the LMS direct solution, it is convenient to rewrite the estimation Eq. (21) in terms of a single adaptive weight vector times an estimator signal vector that is a function of the rotated-source signals. Accordingly, Eq. (21) is rewritten in terms of an adaptive weight vector w₁ that provides linear estimation and an adaptive weight w₂ that provides nonlinear estimation. After unrotation by iₘ, the estimate of the distorted-constellation signal is then,

\hat{e}ₙ=iₘ(w₁′\tilde{ι}ₙ+w₂′h(\tilde{ι}ₙ))], (23a)

where each of the h vector components is a product of one or more real values of a signal combination product selected from the rotated-source signals given in Eq. (19). The adaptive weight w₂ correspond to the b coefficients in Eq. (19). The signal components associated with the weight components in Eq. (21) can be conveniently arranged in the estimator signal vector

hₙ=(hₚₖ⁽ⁿ⁾,p=1,2, . . . P,k=1, . . . Kₚ), (24)

where the ordering follows do-loop notation with the do-loop executing from left to right, i.e. p is the outer loop of signal nonlinearity and k is the inner loop of estimator signal vectors of order p. The estimator weight vector is defined as a compound vector w^{′}=[w₁′w₂′]that forms the dot product with the estimator signal vector Eq. (24) so that Eq.(23a) can be written to give the estimate of the rotated distorted-constellation signal as

iₘ*êₙ=w′hₙ. (23b)

The number of estimator weights W is equal to the number of estimator signal components sum(Kₚ), p=1,2, . . . P, in Eq. 24 (see Table 2 above for examples). The linear term corresponding to the adaptive weight vector component w₁ has K₁=1 with linear subvector

h₁₁⁽ⁿ⁾=\tilde{ι}ₙ.

Comparing with Eq. (19), the nonlinear subvectors in Eq. (24) are from Eq. (19a) with K₂=3:

h₂₁⁽ⁿ⁾= [symbol] e(\tilde{ι}ₙ),

h₂₂⁽ⁿ⁾={ [symbol] e(\tilde{ι}ⱼ*\tilde{ι}ⱼ), i ∈ Cₙ,j ∈ Fₙᵢ},

h₂₃⁽ⁿ⁾={ [symbol] e(\tilde{ι}ᵢ) [symbol] e(\tilde{ι}ⱼ), i ∈ Cₙ,j ∈ Eₙᵢ},

and from Eq. (19b) with K₃=2:

h₃₁⁽ⁿ⁾={ [symbol] e(\tilde{ι}ᵢ) [symbol] e\tilde{ι}ⱼ*\tilde{ι}ₖ), i ∈ Cₙ,j ∈ Cₙ,k ∈ Fₙⱼ},

h₃₂⁽ⁿ⁾={ [symbol] e(\tilde{ι}ᵢ) [symbol] e(\tilde{ι}ⱼ)Re(\tilde{ι}ₖ), i ∈ Cₙ,j ∈ Eₙᵢ,k ∈ Eₙⱼ},

and from Eq. (19c) with K₄=2:

h₄₁⁽ⁿ⁾={ [symbol] e(\tilde{ι}ⱼ*\tilde{ι}ⱼ) [symbol] e(ñ\tilde{ι}ₖ*\tilde{ι}ⱼ), i ∈ Cₙ,j ∈ Fₙᵢ,k ∈ Cₙ,l ∈ Fₙₖ,l ∈ Eₙⱼ},

h₄₂⁽ⁿ⁾={ [symbol] e(\tilde{ι}ⱼ) [symbol] e(\tilde{ι}ⱼ) [symbol] e(\tilde{ι}ₖ) [symbol] e(\tilde{ι}ⱼ), i ∈ Cₙ,j ∈ Eₙᵢ,k ∈ Eₙⱼ,l ∈ Eₙₖ l ∈ Fₙᵢ}.

The LMS direct solution has been widely used in adaptive systems. The mathematical basis and the solution is described in “Least Square Estimation with Applications to Digital Signal Processing” A. A. Giordano and F. M. Hsu, John Wiley & Sons, New York N.Y., 1985, Section 23,3, pgs 28-30, [Giordano]. The LMS direct solution for practical examples in this application can be interpreted as Giordano, Case 2, where a solution is desired to a linear set of equations where there are more equations than unknowns. For N successive previous received signals and the associated successive estimates of the distorted-constellation signals, a set of rotated-residual signals are:

[symbol]

=iₙ*zₙ n=1,2, . . . N. (25)

For adaptation without a test or preamble sequence, the N received signals are random. Setting the rotated-residual signals, Eq. (25), to zero gives a set of N equations in W unknowns. The rotated-residual signal is a noisy value of the rotated distorted-constellation signal. From Eq. (22) and Eq. (23b) above, one has

[symbol]

=iₙ*rₙ−w′hₙ=0 n=1,2, . . . N. (26a )

Let the matrix H be a matrix containing the estimator-signal column vectors hₙ, n=1,2, . . . N. The N equations in W unknowns is then

H′w=\tilde{r}={rₙ*iₙ, n=1,2, . . . N}. (26b)

where the receiver-signal vector \tilde{r} is the complex conjugate of previous rotated-receiver signals in the N rotated-residual signals. Eq. (26b) corresponds to the Giordano Case 2, where the number of equations N exceeds the number of weights W for most practical estimation applications (compare Eq. (26h) with Table 2 for M≧8 and M=4, K≧5). The LMS direct solution is

w=(H H′)⁻¹H\tilde{r} (27)

where the matrix (H H′)⁻¹ H is the projection matrix that projects the receiver-signal vector into the Wth-order weight space. The matrix H H′ is the LMS correlation matrix. There is a maximum of allowable real signal combinations N_{C} in Eq. (19). The projection matrix can be precomputed for the N_{C} allowable combinations. The calculation of the weight vector in Eq. (27) then requires an N_{C} order receiver vector wherein each component is associated with an allowable combination. Some components may not be in the random N-sequence and are then assigned a zero value in the N_{C} order receiver vector. Some components may be repeated in the random N-sequence and these repeat values are averaged and inserted in the N_{C} order receiver vector, in this manner, a corresponding N_{C} order receiver vector for the precomputed W×N_{C} projection matrix is produced from a random N-sequence of receiver signal values.

For each receiver-signal vector component it is necessary to know the associated rotated-source signals that produce the real signal combination. In cancellation systems these source signals are often known and provided to the estimator. In a demodulation system, the source symbols are normally derived from receiver decisions. These factors allow for initialization/adaptation that does not require transmission of known reference sequences.

Since the projection matrix is always the same, the weight vector Eq. (27) is computed by multiplying the N_{C} order receiver-signal vector by the W×N_{C} projection matrix equal to (H H′)⁻¹ H. This direct-calculation solution is mathematically identical to finding the estimator weight vector that minimizes the sum of the magnitude-square values of zₙ over the initialization/adaptation period of n=1,2, . . . N receiver signals. For adaptation using the LMS direct solution, one can either periodic recalculate the weights or update the weights from a previous update period.

It is desirable to use a sequence length N that is selected long enough such that the set of previous receiver signals includes most of each of the unique estimator signal vectors, hₙ, Each unique estimator signal vector is a function of K−1 rotated-source signals, With M constellation values and K−1 different rotated-source signals, there are M^{K-1} possible vectors with an N-sequence at least as large. However in the preferred embodiment, the waveform filter used for both transmitting and matched filtering results in a discrete-time dispersive nonlinear channel response that is a function of the Hermetian autocorrelation of the waveform filter impulse response. Thus as described previously, the nonlinear channel produces Hermetian-sequence symmetry with respect to early and late subblocks of rotated interference signals. Exploiting this Hermetian-sequence symmetry results in F, unique estimator signal vectors with

E=(M+1)M^{K-2}/2, K odd

E=(M/2+1)M^{K-2}, K even (28a)

Thus, the desired N-sequence length is approximately halved as a result of the Hermetian-sequence symmetry. For initialization during modem power-up where a test sequence is used to include all N_{C} combinations, construction of sequences that satisfy Eq. (28) generally requires a length of about twice E.

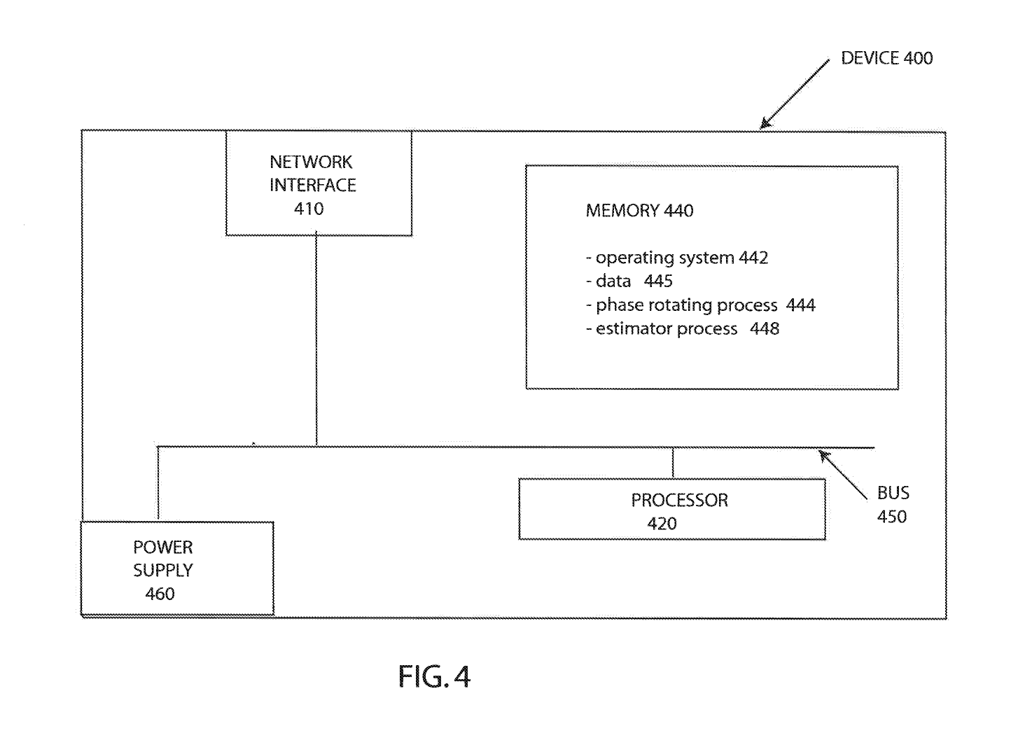

FIG. 4 is a block diagram of an example device 400 that may be used with one or more embodiments described herein, e.g., as a discrete-time nonlinear system for transmission of digital data, as shown in FIG. 1 above. The device 400 may comprise one or more network interfaces 410 (e.g., wired, wireless, etc.), at least one processor 420, and a memory 440 interconnected by a system bus 450, as well as a power supply 460. The network interface(s) 410 contain the signaling circuitry for communicating data to/from the device 400. The network interfaces may be configured to transmit and/or receive data using a variety of different communication protocols. The memory 440 comprises a plurality of storage locations that are addressable by the processor 420 and the network interfaces 410 for storing software programs and data associated with the embodiments described herein. The processor 420 may comprise hardware elements/logic adapted to execute the software programs and manipulate the data 445. An operating system 442, portions of which are typically resident in memory 440 and executed by the processor, functionally organizes the device by invoking operations in support of software processes and/or services executing on the device. These software processes and/or services may comprise phase-rotating process, estimator process, etc., as described above.

It will be apparent to those skilled in the art that other processor and memory types, including various computer-readable media, may be used to store and execute program instructions pertaining to the techniques described herein. Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems an that the computer readable media is stored and executed in a distributed fashion.

Although preferred embodiments of the invention have been described using specific terms, such description is for illustrative purposes only, and it is to be understood that changes and variations may be made without departing from the spirit or scope of the following claims.

### INCORPORATION BY REFERENCE

The entire contents of all patents, published patent applications and other references cited herein are hereby expressly incorporated herein in their entireties by reference.

What is claimed is:

1. A method for use with discrete-time signals in a discrete-time nonlinear channel, comprising:
phase-rotating a plurality of source signals, each of which has been selected from a finite complex constellation, in a block of K successive source signals by a phase rotation value to produce a plurality of rotated-source signals, wherein the phase rotation value is a function of a phase of a sequence-aligned source signal which is produced by sequence aligning one of the plurality of source signals within the block of K successive source signals with an output signal, the output signal including a noise signal and a distorted signal;
producing a plurality of estimator signals, each of which is a product of one or more real values of a signal combination product selected from the plurality of rotated-source signals;
multiplying each of the plurality of estimator signals by an associated estimator weight and summing the products to produce a rotated estimate; and
subtracting the phase rotation value from a phase of the rotated estimate to produce a distorted-signal estimate.

2. The method of claim 1, wherein block length K is odd and the sequence-aligned source signal is a center source signal within the block of K successive source signals and the source signals before and after the center source signal are identified by early and late words, respectively, each word having an associated word weight measure, and wherein the rotated-source signals are complex-conjugate reversed based on a comparison of early and late word weight measures.

3. The method of claim 1, wherein block length K is even and the sequence-aligned source signal is selected as one of two center signals within the block of K successive source signals, the source signals of successive K/2 signals within the block are identified by early and late words, respectively, each word having an associated word weight measure, and wherein the rotated-source signals are complex-conjugate reversed based on a comparison of early and late word weight measures.

4. The method of claim 1, wherein the constellation has a constant envelope and the phase rotation value is equal to the complex conjugate of the sequence-aligned source signal in the block of K successive source signals.

5. The method of claim 4, wherein the estimator weights are calculated by a Least-Mean-Squares direct solution that multiplies a precomputed matrix of estimator signals and a vector of previous output signals that have been phase-rotated by the phase rotation value.

6. A signal estimator for use with discrete-time signals in a discrete-time nonlinear channel, comprising:
a block generator for phase-rotating a plurality of source signals, each of which has been selected from a finite complex constellation, in a block of K successive source signals by a phase rotation value to produce a plurality of rotated-source signals, wherein the phase rotation value is a function of a phase of a sequence-aligned source signal which is produced by sequence aligning one of the plurality of source signals within the block of K successive source signals with an output signal, the output signal including a noise signal and a distorted signal;
an estimator signal generator for producing a plurality of estimator signals, each of which is a product of one or more real values of a signal combination product selected from the plurality of rotated-source signals;
an estimator weight calculator for calculating an associated estimator weight value for each of the plurality of estimator signals; and
a dot-product multiplier for multiplying each of the plurality of estimator signals by the associated estimator weight value and summing the products to produce a rotated estimate and for further multiplying the rotated estimate by the complex conjugate of the rotation value to produce a distorted-signal estimate.

7. The signal estimator of claim 6, wherein block length K is odd and the sequence-aligned source signal is a center source signal within the block of K successive source signals and where the block generator produces source signals before and after the center signal that are identified by early and late words, respectively, each word having an associated word weight measure, and wherein the rotated-source signals are complex-conjugate reversed based on a comparison of early and late word weight measures.

8. The signal estimator of claim 6, wherein block length K is even and the sequence-aligned source signal is selected as one of two center signals within the block of K successive source signals, the source signals of successive K/2 signals within the block are identified by early and late words, respectively, each word having an associated word weight measure, and wherein the rotated-source signals are complex-conjugate reversed based on a comparison of early and late word weight measures

9. The signal estimator of claim 6, wherein the constellation has a constant envelope and the phase rotation value is equal to the complex conjugate of the sequence-aligned source signal in the block of K successive source signals.

10. The signal estimator of claim 9, wherein the estimator weight calculator includes multiplication of a precomputed matrix of estimator signals and a vector of previous output signals, that have been phase-rotated by the rotation value, to produce the estimator weights.
